(19) United States
(12) Patent Application Publication
(10) Pub. No.: US 2015/0019459 A1
(43) Pub. Date: Jan. 15, 2015

(54) PROCESSING OF GESTURES RELATED TO A WIRELESS USER DEVICE AND A COMPUTING DEVICE

(71) Applicant: Amy Han, Palo Alto, CA (US)

(72) Inventor: Amy Han, Palo Alto, CA (US)

(73) Assignee: GOOGLE INC., Mountain View, CA (US)

(21) Appl. No.: 13/028,926

(22) Filed: Feb. 16, 2011

(51) Int. Cl. G06F 3/033; G06F 15/18; G09G 5/00

(52) U.S. Cl. 706/11; 715/863; 345/156

(57) ABSTRACT

In a general aspect, a computer-readable storage medium can be configured to store instructions that when executed cause a processor to perform a process. The instructions can include instructions to detect a gesture defined by an interaction of a user with a surface of a computing device, and initiate a wireless operation associated with a wireless module of the computing device when a representation of the gesture matches a gesture signature stored in a gesture database.

### TECHNICAL FIELD

This description relates to wireless user devices associated with a computing device.

### BACKGROUND

Many known computing devices can have several mechanisms through which a user may interact with (e.g., trigger) one or more functions of the computing device. For example, user devices such as keyboards, printers, mouse devices, touch screen displays and/or so forth, through which a user may interact with computing devices to perform one or more computing functions, can be connected with and/or integrated into the computing devices. However, these user devices may be cumbersome to use and/or may not produce results at a desirable speed and/or level of accuracy.

### SUMMARY

In a general aspect, a computer-readable storage medium can be configured to store instructions that when executed cause a computing device to perform a process. The instructions can include instructions to detect a gesture defined by an interaction of a user with a surface of the computing device, and initiate a wireless operation associated with a wireless module of the computing device when a representation of the gesture matches a gesture signature stored in a gesture database.

In another general aspect, a method can include changing a gesture detection module of a computing device from an operational mode to a learning mode, and defining, while the gesture detection module is in the learning mode, a gesture signature based on a gesture including a first interaction of a user with the computing device. The method can include associating the gesture signature with a wireless operation, and changing the gesture detection module from the learning mode to the operational mode. The method can also include initiating, while the gesture detection module is in the operational mode, the wireless operation when a representation of a gesture including a second interaction of the user with the computing device matches the gesture signature.

In yet another general aspect, an apparatus can include a gesture database configured to store a plurality of gesture signatures associated with a plurality of wireless operations. The apparatus can include a gesture detection module configured access the gesture database and configured to detect a gesture defined by an interaction of a user with a computing device. The gesture detection module can be configured to trigger initiation of a wireless operation from the plurality of wireless operations when a representation of the gesture matches a gesture signature from the plurality of gesture signatures.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates a wireless user device configured to wirelessly communicate with a computing device.

FIG. 2 is a block diagram that illustrates a computing device configured to perform a wireless operation in response to a representation of a gesture.

FIG. 3 is a diagram that illustrates entries in a gesture database.

FIG. 4 is a flowchart that illustrates a method for processing a gesture.

FIG. 5 is a flowchart that illustrates a method for gesture teaching related to a computing device.

FIG. 6 is a block diagram that illustrates a computing device configured to communicate with multiple wireless user devices.

FIG. 7A is a timing diagram that illustrates a representation of a gesture signature.

FIG. 7B is a timing diagram that illustrates a representation of a gesture based on interactions with a computing device.

FIG. 8 is a flowchart that illustrates a method for processing a gesture at a computing device.

### DETAILED DESCRIPTION

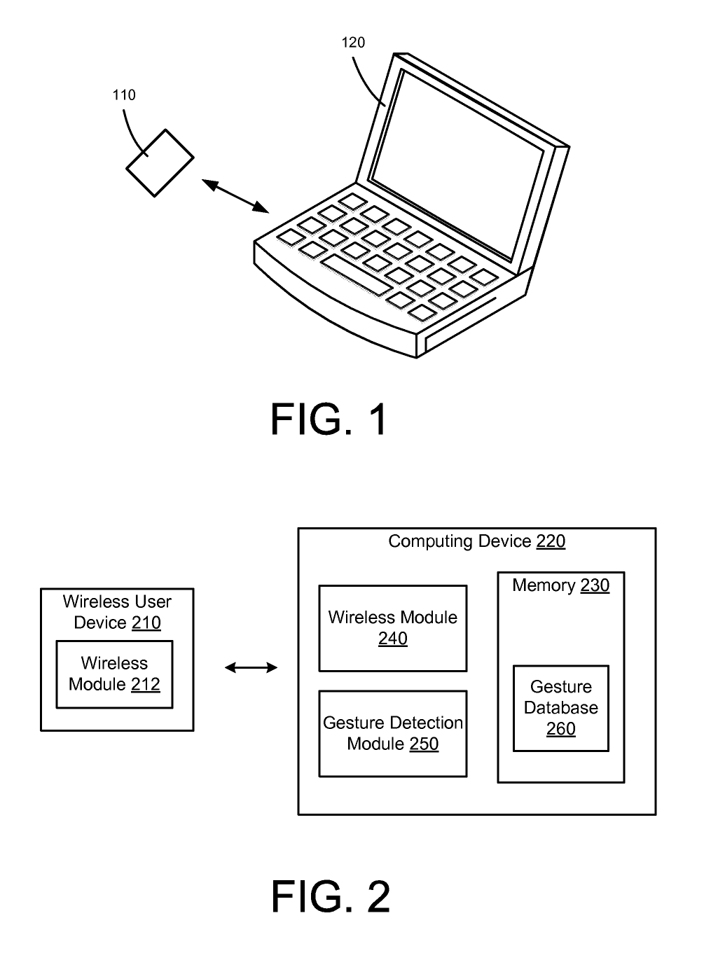

FIG. 1 is a diagram that illustrates a wireless user device 110 configured to wirelessly communicate with a computing device 120. Specifically, the computing device 120 is configured to perform a wireless operation (e.g., initiate a wireless connection, activate a wireless module) with respect to the wireless user device 110 in response to a gesture. In some embodiments, the gesture can be referred to as a gesture interaction. For example, a user may be able to quickly connect a wireless user device 110, such as a Bluetooth mouse, to a computing device 120, such as a laptop device, by simply tapping (as a gesture) the Bluetooth mouse on a frame of the laptop device in a particular pattern, or moving (as a gesture) the Bluetooth mouse near the laptop device in a particular configuration. Thus, the user may not be required to use wireless connectivity menus and/or other mechanisms to establish a connection between the Bluetooth device and the laptop device other than the gesture.

In some embodiments, a gesture can be any type of non-electrical communication with the computing device 120. In some embodiments, a gesture can include a contact (e.g., a sound from a contact) between the wireless user device 110 and the computing device 120. In some embodiments, a gesture can be independent from an user device (e.g., a keyboard, an electrostatic touchpad, a button, a touch sensitive display) already included in (e.g., embedded within) the computing device 120. For example, the gesture can include tapping on a surface of the computing device 120 (e.g., tapping on the surface of the computing device 120 using the wireless user device 110), moving the computing device 120 (e.g., shaking the computing device 120 or a portion thereof), scratching a surface of the computing device 120, and/or so forth. In some embodiments, each of these gestures can be categorized (or classified) as a type of gesture (i.e., a gesture type). For example, tapping on a surface of the computing device 120 can be referred to as a tapping-type gesture, movement of the computing device 120 and/or movement of the wireless user device 110 can be referred to as a movement-type gesture, scratching a surface of the computing device 120 can be referred to as a scratching-type gesture, and so forth.

In some embodiments, the gesture can also include any type of non-verbal communication of the user such as a hand motion or hand signal of a user that can be detected by, for example, a camera device (not shown) of the computing device 120. Visual gestures performed by a user can be referred to as visual-type gestures.

In some embodiments, a gesture can include multiple, separate interactions with the computing device 120. For example, a gesture can include multiple distinct taps on a surface of the computing device 120. In some embodiments, detection of a gesture can be referred to as registration of the gesture, or registering of the gesture.

A wireless operation can be, or can include, for example, any type of wireless operation of a wireless device (e.g., the wireless user device 110, the computing device 120) that can be triggered in response to a gesture. In some embodiments, a wireless operation can include, for example, activating or deactivating a wireless connection sequence associated with a wireless module (not shown) of the computing device 120, termination of an existing wireless connection with the computing device 120, activating or deactivating a portion of a wireless module of the computing device 120, and/or so forth. In some embodiments, the wireless connection sequence can include, for example, searching for a wireless device, synchronizing devices, exchanging passkeys, etc.

A gesture detected at the computing device 120 can be represented in various forms and such representations can be referred to as gesture representations. Although in some embodiments a gesture may be non-electrical, a gesture representation can be, for example, a digital signal (e.g., a binary digital signal, a binary sequence of bits) and/or an analog signal that represents one or more portions of the gesture. For example, a representation of a tapping-type gesture can be a recording of the noise produced during the tapping-type gesture and/or can be a sequence of bit values that represent (e.g., approximately represent) the duration and/or pattern of taps during a tapping-type gesture.

In some embodiments, the wireless user device 110 can include any type of user device that can be configured to wirelessly communicate with the computing device 120. For example, the wireless user device 110 can be, or can include, a wireless keyboard device, a wireless mouse device, a wireless camera device, a wireless printer device, a wireless printer device, a wireless access point (e.g., a wireless router, a wireless gateway device), and/or so forth.

The computing device 120 can be, for example, a wireless device (e.g., wi-fi enabled device) that includes wired components, and can be, for example, a computing entity (e.g., a personal computing device), a server device (e.g., a web server), a tablet computer, a mobile phone, a personal digital assistant (PDA) and/or so forth. The computing device 120 can be configured to operate based on one or more platforms (e.g., one or more similar or different platforms) that can include one or more types of hardware, software, firmware, operating systems, runtime libraries, and/or so forth.

Although the computing device 120 shown in FIG. 1 is shown as a laptop type device, in some embodiments, the computing device 120 can be a user device such as a printer, a wireless access point, and/or so forth. Accordingly, a pairing sequence between two different wireless access points can be triggered in response to a gesture.

FIG. 2 is a block diagram that illustrates a computing device 220 configured to perform a wireless operation in response to a representation of a gesture. Specifically, the computing device 220 is configured to perform a wireless operation with respect to the wireless user device 210 in response to the representation of the gesture. In some embodiments, the components shown in the computing device 220 can be included in a computing device such as computing device 120 shown in FIG. 1.

As shown in FIG. 2, the computing device 220 includes a wireless module 240, and the wireless user device 210 includes a wireless module 212. The wireless module 240 of the computing device 220 is configured to communicate with the user device 210 via of the wireless module 212. The wireless module 240 and the wireless module 212 can each be any type of wireless module (e.g., a wireless network card and associated software) configured to facilitate wireless communication. For example, the wireless module 240 of the computing device 220 can be a wireless module configured to wirelessly communicate using a specified protocol (e.g., a Bluetooth protocol, a Zigbee protocol), and the wireless module 212 of the wireless user device 210 can also be a wireless module configured to communicate using the specified protocol. Accordingly, the computing device 220 and the wireless user device 210 can be configured to communicate using their respective protocol-based wireless modules—wireless module 240 and wireless module 212.

As mentioned in connection with FIG. 1, a wireless operation can be, or can include, for example, any type of wireless operation that can be triggered in response to a gesture (i.e., a representation of a gesture). In some embodiments, a wireless operation can include, for example, activating or deactivating a connection sequence (to establish a wireless connection) associated with the wireless module 240 of the computing device 220. For example, if the wireless module 240 of the computing device 220 is a Bluetooth module, Bluetooth pairing of the wireless module 212 of the wireless user device 210 with the wireless module 240 of the computing device 220 can be initiated in response to a gesture (i.e., a representation of a gesture).

In some embodiments, a wireless operation can include, for example, terminating an existing connection with the wireless module 240 of the computing device 220. For example, if a wireless communication session (or connection) has been established between the wireless module 240 of the computing device 220 and the wireless module 212 of the wireless user device 210, the communication session can be terminated in response to a gesture (i.e., a representation of a gesture).

In some embodiments, a wireless operation can include, for example, activating (e.g., turning on) or deactivating (e.g., turning off) one or more portions of the wireless module 240 of the computing device 220. For example, one more portions of the wireless module 240 can be changed from an inactive state (e.g., a sleep mode, an off state) to an active state (i.e., activated) in response to a gesture being detected (and defined as a representation thereof). After the portion(s) of the wireless module 240 have been changed from the inactive state to the active state, the wireless module 240 can be configured to connect with (e.g., establish a connection with) and/or communicate with wireless user device 210.

In some embodiments, a wireless operation can include, for example, authorizing or blocking (e.g., revoking) authorization of a wireless connection with (e.g., establishment of a wireless connection with) the wireless module 240 of the computing device 220. For example, connection with a specific wireless user device and/or a specific type of wireless user device (e.g., a wireless mouse device) can be authorized in response to a gesture (i.e., a representation of a gesture). In some embodiments, connection with a specific wireless user device and/or a specific type of wireless user device (e.g., a wireless mouse device) may not be allowed (or authorization may be removed) in response to a gesture (i.e., a representation of a gesture).

In some embodiments, a wireless operation can include, for example, triggering use of a specified wireless profile associated with the wireless module 240 of the computing device 220. For example, the wireless profile can include information about one or more passwords that should be used when establishing a connection with the wireless user device 210, a type of protocol for establishing a connection with the wireless user device 210, preferences for use of the wireless user device 210 after a connection has been established, and/or so forth. In some embodiments, at least a portion of a wireless profile can be defined by a user of the computing device 220. Thus, a portion of the wireless profile can be defined in a customized fashion by the user.

As shown in FIG. 2, the computing device 220 includes a gesture detection module 250. The gesture detection module 250 can be configured to process (e.g., detect, analyze) one or more gesture interactions associated with the computing device 220. The gesture detection module 250 can be configured to, for example, detect a gesture (i.e., a gesture interaction), define a representation of the gesture and/or trigger initiation of at least a portion of a wireless operation in response to the gesture (i.e., a representation of a gesture).

The gesture detection module 250 can include any hardware and/or software configured to facilitate processing of one or more gesture interactions associated with the computing device 220. For example, the gesture detection module 250 can include, or can be associated with, one or more sensors such as an accelerometer configured to detect movement of and/or tapping, a gyroscope configured to detect an orientation, an acoustic detection device configured to detect tapping, a proximity detector (configured to detect a proximity of the wireless user device 210 with the computing device 220), a camera device configured to detect movement of a user, and/or so forth.

In some embodiments, the hardware and/or software of a gesture detection module 250 can be configured to actively monitor for a gesture interaction (e.g., actively scan or sample), or can be configured to passively detect a gesture interaction. For example, an accelerometer can be configured to generate a signal when moved in response to an interaction with the computing device 220 that could be a gesture interaction. As another example, a camera device can be configured to periodically capture/generate/process images to constantly monitor for an interaction (e.g., a hand signal, a movement of the wireless user device 210) with respect to the computing device 220 that could be a gesture interaction.

In some embodiments, one or more gesture interactions associated with the computing device 220 can be confirmed using multiple components of a gesture detection module 250 (or using multiple gesture detection modules). For example, the gesture detection module 250 can include a combination of an accelerometer configured to detect a tapping gesture on the computing device 220, and an acoustic detection device configured to detect the tapping gesture on the computing device 220. In some embodiments, a gesture interaction may only be registered when both the accelerometer and the acoustic detection device determine that an interaction with the computing device 220 is, in fact, a gesture interaction. In some embodiments, the accelerometer can be configured to confirm detection of the gesture interaction by the acoustic detection device, or vice versa.

In some embodiments, a wireless operation (or a portion thereof) can be triggered in response to a gesture (i.e., a representation of a gesture) matching a particular gesture signature. The gesture signature can be, or can include, for example, a particular gesture interaction pattern, gesture interaction sequence, gesture interaction timing, and/or so forth. Similar to a representation of a gesture (i.e., a representation of a gesture), a gesture signature can also be, for example, a digital signal (e.g., a binary digital signal, a binary sequence of bits) and/or an analog signal that represents one or more portions of the gesture signature.

For example, a portion of a wireless operation may be triggered in response to tapping (e.g., tapping with a pencil or a portion of the wireless user device 210) on a specified surface of the computing device 220 in a specified fashion (which can correspond with a gesture signature). As another example, a portion of a wireless operation may be triggered in response to the computing device 220 being shaken at a specified rate and/or any specified direction (which can correspond with a gesture signature). In some embodiments, for example, a portion of a wireless operation can be triggered in response to scratching (e.g., scratching with a pencil or a portion of the wireless user device 210) on a specified surface of the computing device 220 in a specified fashion (which can correspond with a gesture signature).

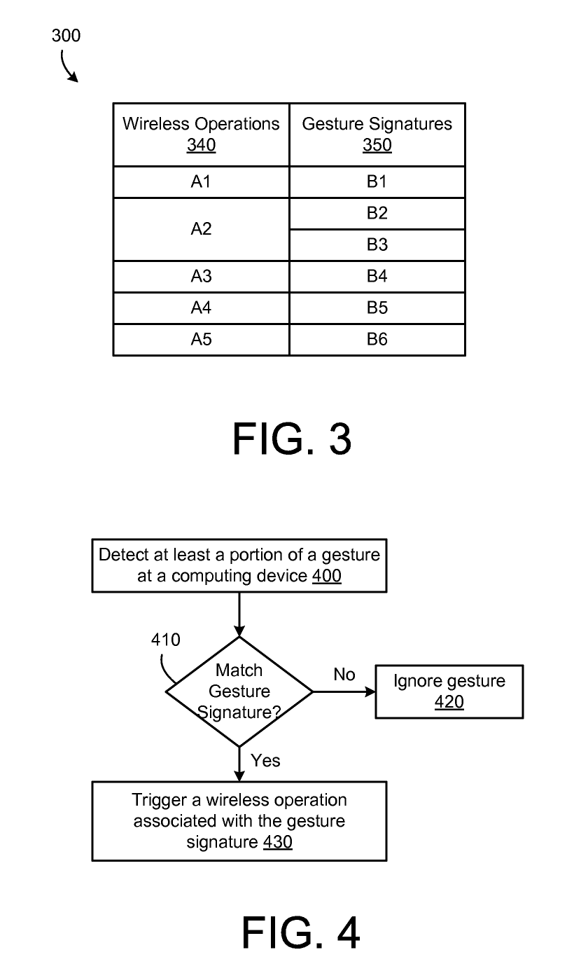

In some embodiments, one or more wireless operations (or portion(s) thereof) can be triggered when a representation of a particular gesture performed by a user matches a gesture signature associated with the wireless operation(s) (or portion(s) thereof) stored in a gesture database 260 of a memory 230 of the computing device 220. The gesture representation, which can be electronically represented, can be compared with an electronic representation of a gesture signature by the gesture detection module 250. For example, a gesture (e.g., a tapping gesture) performed by a user can be detected at the computing device 220 by the gesture detection module 250. The gesture detection module 250 can be configured to determine whether or not a representation of the detected gesture matches a gesture signature stored in the gesture database 260. If the representation of the detected gesture matches the gesture signature, a wireless operation associated with the gesture signature can be performed. If the representation of the detected gesture does not match the gesture signature (or any other gesture signature), a wireless operation may not be performed. An example of entries in a gesture database (such as gesture database 260) is shown in FIG. 3.

FIG. 3 is a diagram that illustrates entries in a gesture database 300. As shown in FIG. 3, the gesture database 300 includes wireless operations 340 (represented as A1 through A5) and gesture signatures 350 (represented as B1 through B6) associated with the wireless operations 340. The wireless operations 340 can be, or can include, for example, activation of a wireless module, initiation of a wireless connection sequence, establishing a connection with a particular wireless user device using a specified wireless profile, authorization to wirelessly connect with a wireless user device, and/or so forth. In some embodiments, the wireless operations 340 can be electronic representations (e.g., sequences of bit values) and/or descriptions of wireless operations. The gesture signatures 350 can be, or can include, for example, tapping on a computing device in a particular sequence, movement of a computing device in a particular pattern, and/or so forth. In some embodiments, the gesture signatures 350 can be electronic representations (e.g., sequences of bit values) and/or descriptions of gesture signatures.

For example, a gesture detection module (such as gesture detection module 250 shown in FIG. 2) can be configured to detect a gesture at a computing device. The gesture detection module can be configured to analyze the a representation of the gesture, and to determine based on the analysis of the gesture whether the representation of the gesture matches one of the gesture signatures 350 included in the gesture database 300. In some embodiments, the analysis can be performed by an analysis portion of the gesture detection module. If the detected gesture (i.e., a representation of a gesture) matches at least one of the gesture signatures 350 included in the gesture database 300, the gesture detection module can be configured to trigger the wireless operation (shown in column 340) associated with the gesture signature 350.

As shown in FIG. 3, multiple gesture signatures 350 can be associated with a wireless operation 340. For example, gesture signature B2 and B3 (shown in the gesture signatures 350 column) are associated with wireless operation A2 (shown in the wireless operations 340 column). In some embodiments, multiple wireless operations 340 can be associated with a single gesture signature 350.

In some embodiments, multiple wireless operations 340 can be triggered in response to detection of multiple gesture signatures 350. For example if gesture signature B1 and gesture signature B5 (shown in column 350) are both matched with a representation of a gesture performed by a user, the wireless operations 340 corresponding with these gesture signatures 350 can be triggered. Specifically, both wireless operation A1 (shown in column 340), which corresponds with gesture signature B1, and wireless operation A5 (shown in column 340), which corresponds with gesture signature B5 can be triggered.

In some embodiments, if multiple gesture signatures 350 are matched with a representation of a gesture by a gesture detection module, multiple conflicting wireless operations 340 can be triggered. Conflicts between one or more of the wireless operations 340 and/or one or more of the gesture signatures 350 can be resolved based on, for example, a rules-based algorithm. In some embodiments, priority values (not shown), which can represent a relative ranking (or precedent value), can be associated with the wireless operations 340 and/or the gesture signatures 350 so that conflicts can be resolved based on priority values.

FIG. 4 is a flowchart that illustrates a method for processing a gesture. As shown in FIG. 4, at least a portion of a gesture is detected at a computing device (block 400). The gesture can be detected by, for example, a gesture detection module (such as gesture detection module 250 shown in FIG. 2). In some embodiments, the gesture can include, for example, tapping on a surface of the computing device, detecting a hand gesture of user using a camera device of the computing device, and/or so forth.

If a representation of the gesture does not match a gesture signature (block 410), the gesture is ignored (block 420). In some embodiments, the representation of the gesture can be compared with many gesture signatures stored in a gesture database. In some embodiments, the representation of the gesture can be compared with each gesture signature in a serial fashion. In some embodiments, the representation of the gesture can be compared with a subset of gesture signature stored in a gesture database based on the gesture being a particular type of gesture. For example, if the gesture is a gesture related to tapping on a surface of the computing device (i.e., a tapping type gesture), the representation of the gesture can be compared with gesture signatures that are tapping type gesture signatures. If the gesture is related to movement of the computing device (i.e., a computing device movement type gesture), the representation of the gesture can be compared with gesture signature related to movement of the computing device. Gesture signatures can be associated with specified gesture types, and the gesture types can be included in a gesture database.

If the representation of the gesture matches a gesture signature (block 410), a wireless operation associated with the gesture signature can be triggered (block 420). In some embodiments, the wireless operation can include, for example, initiating a wireless connection sequence, activating a portion of the wireless module of the computing device, and/or so forth.

Referring back to FIG. 2, in some embodiments, a gesture (and/or gesture signature) can include a combination of various types of gestures. For example, a gesture can including a combination of a non-electrical communication with the computing device 220 such as tapping on the surface of the computing device 220, and a non-verbal communication of a user such as a hand motion of a user that can be detected by, for example, a camera device (not shown) of the computing device 220. Thus, the gesture can include a tapping-type gesture and a visual-type gesture.

In some embodiments, one or more gesture signatures that can be used to trigger one more wireless operations of the computing device 220 (or a portion thereof) can be learned by the gesture detection module 250. Specifically, the gesture detection module 250 (or a portion thereof) can be trained to process one or more gestures (or representations thereof) based on one or more customized gesture signatures.

For example, the gesture detection module 250 can be changed from an operational mode (e.g., an analyzing mode) to a learning mode. When in the learning mode, the gesture detection module 250 can be configured to associate a specified gesture (i.e., a specified gesture representation) with a wireless operation. The specified gesture can be stored as a gesture signature in, and associated with the wireless operation in, for example, a gesture database. Accordingly, when the gesture detection module 250 is in the operational mode, the specified gesture (i.e., representation of the gesture) can be used by the gesture detection module 250 to trigger the wireless operation.

For example, a user can change the gesture detection module 250 from an operational mode to a learning mode (during a learning time period). While in the learning mode, the gesture detection module 250 can be triggered (e.g., triggered by the user) to associate a specified gesture(s) (i.e., a specified gesture representation) with, for example, a wireless operation. The specified gesture can be referred to as a teaching gesture. After triggering the association, the user can change the gesture detection module 250 from the learning mode back to the operational mode. While in the operational mode (during an operational time period), the gesture detection device 250 can be configured to detect a gesture at the computing device 220 (and can be configured to define a gesture representation based on the gesture). The gesture during the operational mode can be referred to as an operational gesture. The gesture detection module 250 can be configured to determine that the operational gesture is associated with the wireless operation based on the association performed while the gesture detection module 250 was in the learning mode. Specifically, the gesture detection module 250 can be configured to associate a representation of the operational gesture with the wireless operation based on, for example, a match (through a comparison) of the representation of the operational gesture with a representation of the teaching gesture.

As a specific example, a user can change the gesture detection module 250 from an operational mode to a learning mode (during a learning time period). While in the learning mode, the gesture detection module 250 can be triggered (e.g., triggered by the user) to associate a tapping-type gesture with a specified pattern with, for example, a wireless operation. While in the operational mode (during an operational time period), the gesture detection device 250 can be configured to detect a gesture at the computing device 220 and can be configured to define a representation of the gesture. If the representation of the gesture performed while in the operational mode matches the tapping-type gesture with the specified pattern, the wireless operation can be performed.

In some embodiments, one or more customized gestures can be defined using a user device associated with the computing device 220. For example, one or more customized gesture signatures (and associated wireless operations) can be uploaded to the computing device 220 and/or can be defined using a keyboard of the computing device 220. In such embodiments, the gesture detection module 250 may not be in a learning mode.

In some embodiments, one or more wireless operations that can be performed by the computing device 220 can be customized. For example, a wireless operation can be related to establishment of a connection between the computing device 220 and the wireless user device 210. A wait time period before attempting establishment of the wireless connection during execution of the wireless operation and/or a number of attempts to establish the wireless connection during execution of the wireless operation can be parameters defined in a customized fashion by a user.

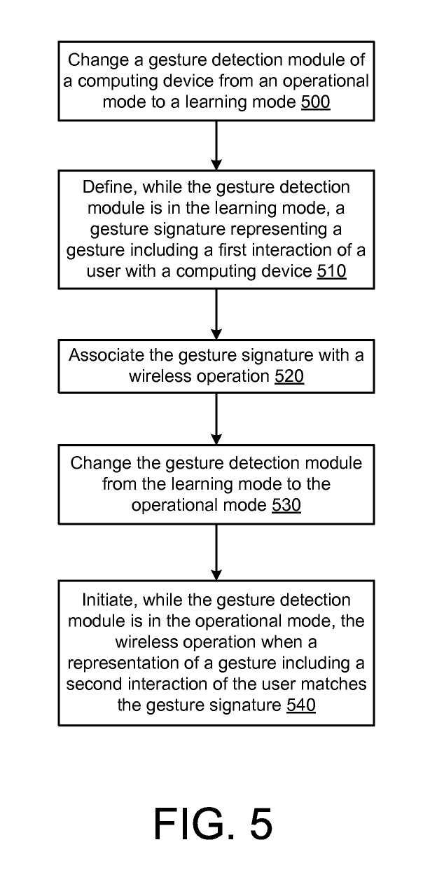

FIG. 5 is a flowchart that illustrates a method for gesture teaching related to a computing device. In some embodiments, one or more portions of the method shown in FIG. 5 can be performed by the computing device 220 shown in FIG. 2.

As shown in FIG. 5, a gesture detection module of a computing device is changed from an operational mode to a learning mode (block 500). In some embodiments, the gesture detection module can be changed from the operational mode to the learning mode by, for example, a user of the computing device.

While the gesture detection module is in the learning mode, a gesture signature representing a gesture including a first interaction of a user with the computing device is defined (block 510). In some embodiments, the gesture including the first interaction can be any type gesture.

The gesture signature is associated with a wireless operation (block 520). In some embodiments, the wireless operation can be selected from, for example, a list of wireless operations that can be triggered in conjunction with a wireless module of the computing device. In some embodiments, the gesture signature and the selected wireless operation can be stored as at least one entry in a gesture database.

The gesture detection module is changed from the learning mode the operational mode (block 530). In some embodiments, the gesture detection module can be changed from the learning mode back the operational mode by a user of the computing device. Although not shown in FIG. 5, in some embodiments, more than one gesture representation can be associated with more than one wireless operation while the computing device is in the learning mode.

While the gesture detection module is in the operational mode, the wireless operation is initiated when a representation of a gesture including a second interaction of a user with a surface of a computing device matches the gesture signature (block 540). In some embodiments, the gesture including the second interaction can be any type gesture. Wireless operation can be initiated when the representation of the gesture defined by the second interaction matches (or substantially matches) the gesture signature, which represents the gesture defined by the first interaction. For example, the gesture signature can be tapping on a surface of the computing device with a specified sequence of taps, and the gesture defined by the second interaction can be tapping on the surface of the computing device with the specified sequence of taps.

Referring back to FIG. 2, in some embodiments, the gesture detection module 250 can be included in a particular location of the computing device 220 so that a gesture signature can be detected in a desirable fashion. For example, the gesture detection module 250 can be installed in (or proximate to) a portion of the computing device 220 specified for gesture interactions. Specifically, an acoustic detection device can be installed near a surface of the computing device 220 specified for a gesture interaction (such as tapping). The surface of the computing device 220 specified for the gesture interaction can be referred to as a gesture zone.

In some embodiments, the wireless user device 210 can be configured with gesture analysis capability similar to that of the computing device 220. The wireless user device 210 can include the components included in the computing device 220 (e.g., the gesture detection module 250 of the computing device 220, etc.). One or more wireless operations of the wireless user device 210 can be triggered in response to one or more gestures detected by (and/or at) wireless user device 210.

Specifically, in some embodiments, a gesture detection module such as the gesture detection module 250 can be included in wireless user device 210. In such embodiments, the wireless user device 210 can include a sensor, such as an accelerometer, a gyroscope, and/or so forth that can be used to produce one or more signals associated with one or more gesture interactions. In some embodiments, movement of the wireless user device 210 can be detected at the wireless user device 210 as a gesture and can be used to trigger a wireless operation (via one or more instructions/commands) at the wireless user device 210 and/or the computing device 220 (after being sent to the computing device 220).

For example, a wireless operation can be triggered at the wireless user device 210 and/or the computing device 220 in response to a waving of the wireless user device 210 in a particular pattern with a specified proximity to the computing device 220. In such embodiments, the gesture can be processed at the wireless user device 210 and/or the computing device 220. In such embodiments, the wireless user device 210 and/or the computing device 220 can be configured to trigger (via a communicated instruction) a wireless operation at the wireless user device 210 and/or the computing device 220. As another example, a wireless module of the wireless user device 210 can be activated in response to tapping on the wireless user device 210 and/or tapping the wireless user device 210 against another device such as the computing device 220. In some embodiments, for example, a connection between the wireless user device 210 and the computing device 220 can be triggered in response to a gesture (e.g., a tapping gesture) associated with the wireless user device 210 (without interacting directly with the computing device 220). In some embodiments, the wireless user device 210 can include one or more a sensors (e.g., accelerometers, gyroscopes) that produce signals that can be wirelessly communicated to the computing device 220 and processed at the computing device 220 as one or more gesture interactions.

When the wireless user device 210 includes gesture processing capability similar to (or the same as) that of the computing device 220, a gesture can be registered (e.g., registered mutually) by both the wireless user device 210 and the computing device 220. The mutually registered gesture can trigger one or more wireless operations to be initiated. For example, the wireless user device 210 can be tapped against a surface of the computing device 220. The tapping can be registered as a gesture at the wireless user device 210 and can also be registered as a gesture at the computing device 220. A wireless operation (e.g., a wireless connection sequence) can be triggered in response the tapping being registered at both the wireless user device 210 and the computing device 220 as a gesture. In some embodiments, one or more wireless operations (e.g., a wireless connection sequence) between the wireless user device 210 and the computing device 220 can be triggered in response to separate interactions with each of the wireless user device 210 and the computing device 220 being separately registered.

In some embodiments, if the wireless user device 210 and/or the computing device 220 does not register the tapping as a gesture, the wireless operation may not be initiated (e.g., may be prevented) by the wireless user device 210 and/or the computing device 220. For example, if the wireless user device 210 did not register the tapping as a gesture, the wireless user device 210 can be configured to prevent the wireless operation from being initiated. In some embodiments, the wireless user device 210 and/or the computing device 220 may send an acknowledgment of the gesture in order for a wireless operation to be initiated.

In some embodiments, a wireless operation may be triggered at the computing device 220 in response to a gesture (i.e., a representation of a gesture) only when authorized to do so. Said differently, the computing device 220 may not trigger (e.g., trigger execution of) a wireless operation in response to a representation of a gesture if the computing device 220 is not authorized to trigger execution of the wireless operation in response to the representation of the gesture. For example, the computing device 220 may be authorized to initiate a first wireless operation in response to a representation of a first gesture, but may not be authorized to initiate a second wireless operation in response to a representation of a second gesture. In some embodiments, the computing device 220 may be authorized to initiate a wireless operation with respect to the wireless user device 210, but not with respect to a second wireless user device (not shown). In some embodiments, authorization related to wireless operations and/or wireless user devices can be stored in, for example, a gesture database such as that shown in FIG. 3.

In some embodiments, one or more wireless operations can be triggered in response to a gesture and a signal received from one or more user devices associated with the computing device 220. Said differently, one or more wireless operations may only be triggered in response to a combination of a representation of a gesture and an additional user input (e.g., a user value, a passcode). For example, the gesture detection module 250 can be configured to register an interaction of a user with the computing device 220 as a gesture. However, the gesture detection module 250 may not trigger a wireless operation based on a representation of the gesture until a signal (e.g., a passwords, a combination of commands) is received from another user device of the computing device such as a keyboard. The signal can be, or can represent, for example, authorization to trigger the wireless operation based on the gesture (i.e., representation of the gesture).

In some embodiments, a user-interface (not shown), through which one or more wireless operations can be initiated, can be displayed in response to a gesture. For example, the gesture detection module 250 can be configured to register an interaction of a user with the computing device 220 as a gesture (e.g., a tapping gesture). In some embodiments, the gesture can be registered when a representation of the gesture matches a gesture signature. The gesture detection module 250 can be configured to trigger display of a user-interface (e.g., a wireless device manager) through which a wireless operation can be initiated in response to the gesture (e.g., the matching of the representation of the gesture with the gesture signature).

The memory 230 of the computing device 220 can be any type of memory device such as a random-access memory (RAM) component or a disk drive memory. As shown in FIG. 2, the memory 230 is a local memory included in the computing device 220. Although not shown, in some embodiments, the memory 230 can be implemented as more than one memory component (e.g., more than one RAM component or disk drive memory) within the computing device 220. In some embodiments, the memory 230 can be, or can include, a non-local memory (e.g., a memory not physically included within the computing device 220) within a network (not shown). For example, the memory 230 can be, or can include, a memory shared by multiple computing devices (not shown) within a network. In some embodiments, the memory 230 can be associated with a server device (not shown) on a client side of a network and configured to serve several computing devices on the client side of the network.

The components of the computing device 220 (e.g., the gesture detection module 250) can be configured to operate within an environment that includes an operating system. In some embodiments, the operating system can be configured to facilitate, for example, detection of gestures by the gesture detection module 250.

In some embodiments, the computing device 220 can represent a cluster of devices. In such an embodiment, the functionality and processing of the computing device 220 (e.g., the gesture detection module 250 of the computing device 220) can be distributed to several computing devices of the cluster of computing devices.

In some embodiments, one or more portions of the components shown in the computing device 220 in FIG. 2 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some embodiments, one or more portions of the gesture detection module 250 can be, or can include, a software module configured for execution by at least one processor (not shown). In some embodiments, the functionality of the components can be included in different modules and/or components than those shown in FIG. 2. For example, although not shown, the functionality of the gesture detection module 250 can be included in a different module than the gesture detection module 250, or divided into several different modules.

In some embodiments, the computing device 220 can be included in a network. In some embodiments, the network can include multiple computing devices (such as computing device 220) and/or multiple server devices (not shown). Also, although not shown in FIG. 2, the computing device 220 can be configured to function within various types of network environments. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can be have portions based on various protocols such as Internet Protocol (IP) and/or a proprietary protocol. The network can include at least a portion of the Internet.

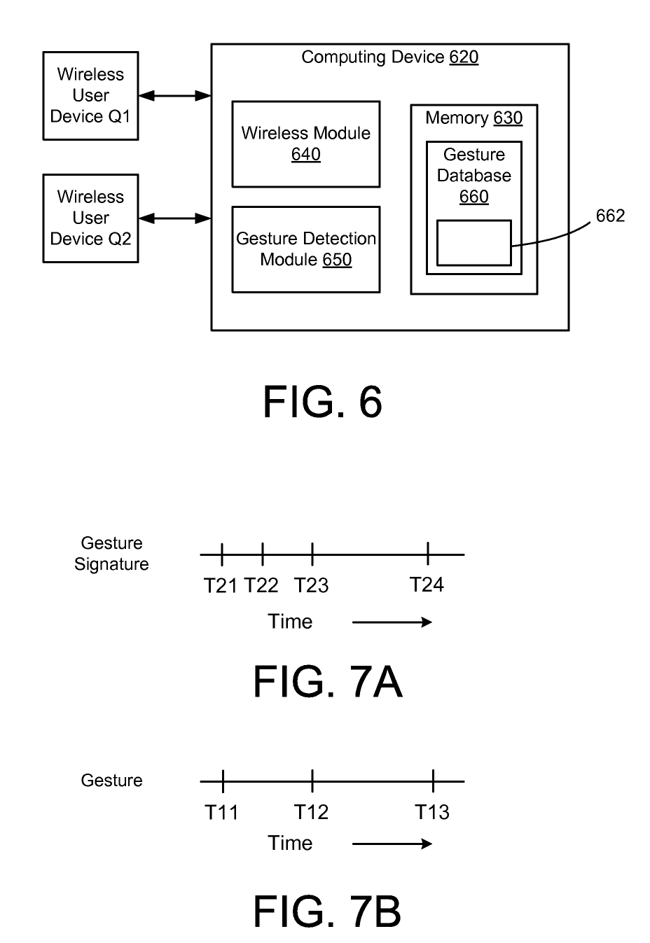

FIG. 6 is a block diagram that illustrates a computing device 620 configured to communicate with multiple wireless user devices. The computing device 620 includes a memory 630, a wireless module 640, and a gesture detection module 650. A gesture database 660 is stored in memory 630 of the computing device 620. In this embodiment, the computing device 620 is configured to perform one or more wireless operations with respect to wireless user device Q1 and wireless user device Q2. In some embodiments, wireless user devices Q1 and Q2 can be any type of wireless user devices.

In this embodiment, the gesture database 660 includes wireless profiles 662 (e.g., a set of wireless profiles). The wireless profiles 662 can include specific information related to a wireless relationship between the computing device 620 and the wireless user device Q1 and/or related to a wireless relationship between the computing device 620 and the wireless user device Q2. For example, the wireless profiles 662 can include information a type of protocol for establishing a connection with the wireless user devices Q1 and Q2.

In this embodiment, one or more of the wireless profiles 662 can be accessed and applied to each of the wireless user devices Q1 and Q2 in response to one or more gestures (or representations thereof). For example, a first wireless profile can be accessed in response to a representation of a first gesture matching a first gesture signature associated with the first wireless profile from the wireless profiles 662. A second wireless profile can be accessed in response to a representation of a second gesture matching a second gesture signature associated with the second wireless profile from the wireless profile 662. Although FIG. 6 illustrates wireless profile 662 in connection with wireless user device Q1 and Q2, the embodiments described in connection with FIG. 6 can be associated with any type of wireless operation.

In some embodiments, wireless operations can be performed with respect to the wireless user devices Q1 and Q2 in a serial fashion or in a parallel fashion. For example, the computing device 620 can be configured to wirelessly connect (using the wireless module 640) with wireless user device Q1 in response to a representation of a first gesture performed during a first time period, and the computing device 620 can be configured to wirelessly connect (using the wireless module 640) with wireless user device Q2 in response to a representation of a second gesture performed during a second time period. In some embodiments, for example, the computing device 620 can be configured to wirelessly connect (using the wireless module 640) with wireless user device Q1 and Q2 in response to a representation of a single gesture (which can be defined by an interaction with the computing device 620).

In some embodiments, one or more wireless operations can be performed with respect to a wireless user device when the wireless user device is activated. For example, wireless user device Q1 can be changed from an inactive state (e.g., an off state, a sleep state) to an active state (e.g., an on state), while wireless user device Q2 can remain in an inactive state. Thus, a wireless operation triggered in response to a representation of a gesture can be performed with respect to the wireless user device Q1, which is in an active state, as opposed to the wireless user device Q2, which is in an inactive state.

FIG. 7A is a timing diagram that illustrates a representation of a gesture signature. As shown in FIG. 7A, time is increasing to the right, and the gesture signature has a temporal configuration (e.g., a predefined temporal configuration). Specifically, each of the times T21, T22, T23, and T24 represent times of taps against a surface of a computing device as part of the gesture signature. In some embodiments, the gesture signature can be associated with a wireless operation. Accordingly, a representation of a gesture that matches the gesture signature can trigger execution of the wireless operation.

FIG. 7B is a timing diagram that illustrates a representation of a gesture based on interactions with a computing device. In some embodiments, the gesture can be performed in connection with a specified wireless device to be associated with (or already associated with) the computing device. As shown in FIG. 7B, time is increasing to the right, and the gesture signature has a temporal configuration. Specifically, each of the times T11, T12, and T13 represent times of taps against a surface of the computing device as part of the gesture.

As shown in FIG. 7B, the tap at time T11 is aligned with the tap at time T21 (shown in FIG. 7A), the tap at time T12 is aligned with the tap at time T 23 (shown in FIG. 7A), and the tap at time T13 is aligned with the tap at time T24 (shown in FIG. 7A). However, the gesture signature shown in FIG. 7A does not match the representation of the gesture shown in FIG. 7B because the tap of the gesture signature at time T22 shown in FIG. 7A is not aligned with a corresponding tap of the representation of the gesture shown in FIG. 7B. Accordingly, a wireless operation associated with the gesture signature shown in FIG. 7A may not be triggered in response to the representation of the gesture shown in FIG. 7B.

In some embodiments, a representation of the taps associated with the gesture shown in FIG. 7B can be compared (by a gesture detection module) with the representation of the taps associated with the gesture signature shown in FIG. 7A. In some embodiments, a gesture detection module can be configured to trigger execution of the wireless operation associated with the gesture signature shown in FIG. 7A when a representation of a gesture (not shown) substantially matches (within specified bounds) the gesture signature shown in FIG. 7A. In some embodiments, a computing device can be configured to notify a user (via a notification (e.g., a user interface notification)) that a representation of a gesture (such as the gesture shown in FIG. 7B) does or does not match a gesture signature (such as the gesture signature shown in FIG. 7A)

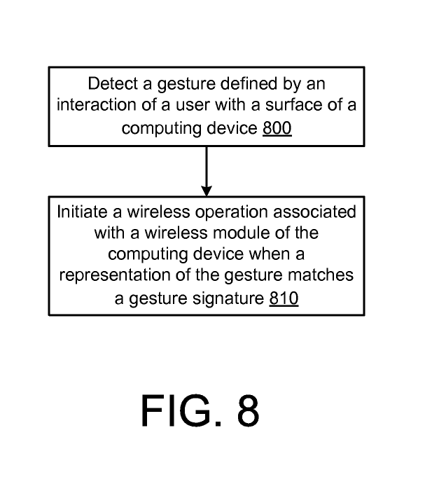

FIG. 8 is a flowchart that illustrates a method for processing a gesture at a computing device. The computing device can be, for example, a computing device such as the computing devices shown in FIG. 1 or FIG. 2.

As shown in FIG. 8, a gesture defined by an interaction of a user with a surface of the computing device is detected (block 800). In some embodiments, the interaction of the user can be, for example, tapping on a surface of the computing device. In some embodiments, the interaction of the user can be registered as a gesture by, for example, a gesture detection module (such as gesture detection module 250 shown in FIG. 2).

Although not shown in FIG. 8, in some embodiments, the interaction of the user with a surface of the computing device may not be registered as a gesture. For example, if the interaction of user with a surface of the computing device does not meet a threshold condition for an interaction to be registered as a gesture, the interaction of the user with the computing device may be ignored. The threshold condition can include, for example, a specified level of regularity of gesture-related interactions, a specified time interval between interactions of the user with the surface of the computing device during a gesture, and/or so forth.

In some embodiments a threshold condition can be defined for various types of gesture interactions. For example, a threshold condition for a movement-type gesture can include movements of a computing device at a specified speed and/or within a specified distance.

A wireless operation associated with a wireless module of the computing device is initiated when a representation of the gesture matches a gesture signature (block 810). The wireless operation can be retrieved from a gesture database based on the wireless operation being associated with the gesture signature stored in the gesture database.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user ca provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments. It should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

1. A method, comprising:
changing a gesture detection module of a computing device from an operational mode to a learning mode;
defining, while the gesture detection module is in the learning mode, a first gesture signature based on a gesture including a first interaction of a user with the computing device, the first interaction including tapping the computing device with a wireless device;
associating the first gesture signature with a first wireless operation, the first wireless operation including at least initiating a wireless connection sequence;
changing the gesture detection module from the learning mode to the operational mode;
defining, while the gesture detection module is in the operational mode, a representation of the gesture based a second interaction of the user with the computing device, the second interaction including tapping the computing device with the wireless device;
matching the representation of the gesture with a corresponding gesture signature from a plurality of gesture signatures, including:
resolving a conflict identified during the matching, between the first gesture signature and a second gesture signature different from the first gesture signature, or between the first wireless operation and a second wireless operation, based on a specified threshold condition associated with at least one characteristic of the representation of the gesture compared with a characteristic of the first gesture signature; and
when a conflict is not identified during the matching, matching the representation of the gesture with the first gesture signature; and
initiating, while the gesture detection module is in the operational mode, the first wireless operation in response to resolving the conflict and matching the representation of the gesture with the first gesture signature.

2. The method of claim 1, wherein the gesture includes a series of taps against a surface of the computing device, and the first interaction is a tap from the series of taps.

3. The method of claim 1, wherein the first wireless operation includes a Bluetooth pairing sequence of a Bluetooth wireless module of the computing device with a Bluetooth wireless module of the wireless user device.

4. (canceled)

5. The method of claim 1, wherein the second wireless operation includes termination of a wireless connection between a wireless module of the computing device and a wireless module of the wireless user device.

6. The method of claim 1, wherein the associating includes selecting the wireless operation from a plurality of wireless operations while the gesture detection module is in the learning mode.

7. The method of claim 1, wherein the second wireless operation includes at least one of authorizing or revoking authorization of establishment of a wireless connection between a wireless module of the computing device and a wireless module of the wireless user device.

8. A non-transitory computer-readable storage medium storing instructions that when executed cause a computing device to perform a process, the instructions comprising instructions to:
detect a gesture defined by an interaction of a user with a surface of the computing device, the interaction including tapping a surface of a first wireless user device to the surface of the computing device;
define a representation of the gesture in response to the detecting;
resolve, based on the representation of the gesture and based on a rules-based algorithm, a conflict between a first gesture signature and a second gesture signature different from the first gesture signature or a conflict between a first wireless operation and a second wireless operation, by comparing a specified threshold condition associated with at least one characteristic of the representation of the gesture compared with a characteristic of the first gesture signature; and
initiate the first wireless operation associated with a wireless module of the computing device when the resolving indicates the representation of the gesture corresponds to the first gesture signature.

9. The computer-readable storage medium of claim 8, wherein at least one of the first gesture signature or the second gesture signature includes a series of taps having a specified temporal configuration.

10. The computer-readable storage medium of claim 8, wherein the first wireless operation includes establishing a wireless connection with the first wireless user device and a second wireless user device.

11. The computer-readable storage medium of claim 8, wherein the gesture is a first gesture and the interaction is a first interaction, the first gesture signature and the second gesture signature are from a plurality of gesture signatures,
the instructions further comprising instructions to:
detect a second gesture defined by a second interaction of a user with the computing device; and
send a notification that a representation of the second gesture does not match any gesture signature from the plurality of gesture signatures.

12. The computer-readable storage medium of claim 8, wherein the first wireless operation includes changing at least a portion of the wireless module from an inactive state to an active state.

13. The computer-readable storage medium of claim 8, wherein the wireless module is a Bluetooth wireless module, and the wireless operation includes a Bluetooth pairing sequence.

14. (canceled)

15. An apparatus including instructions stored on a non-transitory computer-readable medium and executable by at least one processor, comprising:
a gesture database configured to store a plurality of gesture signatures associated with a plurality of wireless operations, the plurality of wireless operations including initiation of a wireless connection sequence or termination of a wireless connection; and
a gesture detection module configured to cause the at least one processor to access the gesture database and to detect a gesture defined by an interaction of a user with the apparatus, the interaction of the user including tapping the apparatus with a wireless device,
the gesture detection module configured to cause the at least one processor to trigger initiation of at least one wireless operation from the plurality of wireless operations based on a representation of the gesture and in response to resolving a conflict between matches to at least two gesture signatures from the plurality of gesture signatures related to the interaction of the user, resolving the conflict including comparing a specified threshold condition associated with at least one characteristic of the representation of the gesture compared with a corresponding characteristic of the matches identified from the plurality of gesture signatures.

16. The apparatus of claim 15, wherein the representation of the gesture includes a series of taps having a temporal configuration that matches a predefined temporal configuration of a series of taps of a corresponding gesture signature of the plurality of gesture signatures.

17. The apparatus of claim 15, wherein at least one gesture signature from the plurality of gesture signatures is a customized gesture signature defined while the gesture detection module is in a learning mode.

18. The apparatus of claim 15, wherein the at least two gesture signatures includes a first gesture signature and a second gesture signature, the gesture detection module is configured to resolve, based on a rules-based algorithm, that the first gesture signature has priority over the second gesture signature.

19. The apparatus of claim 15, further comprising:
a wireless module, the wireless operation includes changing at least a portion of the wireless module from an inactive state to an active state.

20. The apparatus of claim 15, further comprising:
a camera device associated with the gesture detection module, the representation of the gesture includes an image captured using the camera device.

21. The method of claim 1, wherein:
the first interaction includes tapping the wireless device to the computing device with a series of taps having a specified pattern within a specified time period, and
the second interaction includes tapping the wireless device to the computing device with the series of taps having the specified pattern within the specified time period.

22. The method of claim 1, wherein:
the first interaction includes tapping a surface of the wireless device to a surface of the computing device with a series of taps having a specified temporal configuration within a specified period of time, and
the second interaction includes tapping a surface of the wireless device to the surface of the computing device with the series of taps having the specified temporal configuration within the specified period of time.

23. The computer-readable storage medium of claim 8, wherein the second gesture signature is different from the first gesture signature.

24. The apparatus of claim 15, wherein the at least two gesture signatures includes a first gesture signature and a second gesture signature, the first gesture signature is different from the second gesture signature.
